(19) United States
(12) Patent Application Publication
(10) Pub. No.: US 2010/0182355 A1
(43) Pub. Date: Jul. 22, 2010

(54) INKJET RECORDING DEVICE AND METHOD FOR CONTROLLING THE SAME

(76) Inventor: Seiichi Inoue, Kanagawa-ken (JP)

Correspondence Address: BIRCH STEWART KOLASCH & BIRCH, PO BOX 747, FALLS CHURCH, VA, 22040-0747, US

(21) Appl. No.: 12/690,753

(22) Filed: Jan. 20, 2010

(30) Foreign Application Priority Data
Jan. 21, 2009 (JP) 010503/2009

(51) Int. Cl. B41J 3/00

(52) U.S. Cl. 347/2

(57) ABSTRACT

An inkjet recording device includes: an electrostatic inkjet recording unit having at least one nozzle for ejecting ink with an electrostatic force, the electrostatic inkjet recording unit printing a plurality of disparity images by ejecting the ink onto a surface of a lenticular sheet, the lenticular sheet including an array of lenticular lenses, each lenticular lens having a predetermined width and a convex cross-sectional shape, and the disparity images being printed correspondingly to the predetermined width on the surface of the lenticular sheet opposite from a surface of the lenticular sheet having the convex shapes of the lenticular lenses; a scanning unit for two-dimensionally moving the electrostatic inkjet recording unit relative to the lenticular sheet; and a controlling unit for controlling driving of the electrostatic inkjet recording unit and the scanning unit.

### BACKGROUND OF THE INVENTION

1. Field of the Invention

The present invention relates to an inkjet recording device which prints an image on a lenticular sheet to form a stereoscopic image, and a method for controlling the inkjet recording device.

2. Description of the Related Art

It has been known that stereoscopic viewing using disparity can be achieved by combining more than one images and three-dimensionally displaying the combined image. Such stereoscopic viewing can be achieved by taking more than one images of the same subject with more than one cameras placed at different positions to acquire more than one images having a disparity therebetween (referred to as disparity images), and three-dimensionally displaying the images with utilizing a disparity between the subject images contained in the disparity images.

As a technique for three-dimensionally displaying such images, lenticular print has been known. The lenticular print is formed by preparing a lenticular sheet having an array of lenticular lenses, each lens having a convex cross section, and alternately printing the disparity images, which have been cut into strips, on the respective lenticular lenses. A viewer of such a lenticular print can stereoscopically view the printed image due to the disparity between the eyes.

In order to form such a lenticular print, it is necessary to print the strips of the plurality of disparity images within the width of each lenticular lens. For example, if there are three disparity images, it is necessary to print a set of strips of three disparity images on one lenticular lens. However, if the position of each set of disparity images printed on the lenticular sheet is out of the width of each corresponding lenticular lens, the printed image cannot provide stereoscopic viewing and/or the image quality is degraded due to moire. In order to address this problem, a technique has been proposed, in which positional misalignment between the lenticular lens and the disparity images is detected, and the disparity images are printed on the lenticular sheet with aligning the positions of the lenticular lens and the disparity images (see U.S. Pat. No. 5,812,152, which is hereinafter referred to as patent document 1).

The technique disclosed in patent document 1 uses an inkjet recording device to print the disparity images on the lenticular sheet. As an inkjet recording method, an electrostatic inkjet recording method has been proposed (see Japanese Unexamined Patent Publication No. 2004-230653, which is hereinafter referred to as patent document 2). The electrostatic inkjet recording method uses an ink containing a charged particulate component, and controls ejection of the ink according to image data representing an image to be printed by using an electrostatic force, which is generated by applying a predetermined voltage to an ejection electrode serving as a nozzle of an inkjet head, to print the image.

An angular range in which stereoscopic viewing of a lenticular print is achieved can be increased by increasing the number of the disparity images forming the lenticular print. However, if the number of the disparity images is increased, the number of images to be printed on each one lenticular lens is increased, and thus a higher printing resolution is necessary.

Further, lenticular prints have patterned indents formed by the lenticular lenses on the surface thereof, and thus texture and feeling of the lenticular prints are inferior to those of ordinary prints. In order to bring the texture and feeling of the lenticular prints closer to those of the ordinary prints, it may be considered to reduce the lens height of the lenticular lenses. However, if the height of the lenticular lenses is reduced, it is also necessary to reduce the lens width. Therefore, even higher printing resolution is required to print the increased number of disparity images within the reduced lens width.

The lenticular sheet is typically made of a transparent resin, such as PC (polycarbonate) or PP (polypropylene). When inkjet printing is carried out on such a resin medium, the ink which has landed on the medium and is still wet spreads wider than when the ink is printed on a paper medium. Therefore, when the disparity images are printed at a higher resolution, colors of the disparity images may mix, and this may hinder successful stereoscopic viewing.

In order to address this problem, it may be considered to form an ink receiving layer on the print surface of the lenticular sheet. However, although the ink receiving layer can prevent the spread of the wet ink, the ink receiving layer is typically porous and this may degrade optical properties of the lenticular sheet.

Further, directional accuracy of ink ejection with inkjet systems is not so high. Therefore, when the disparity images are printed as the lenticular print, adjacent disparity images may overlap to degrade separability between the images or unintentionally unprinted areas may be generated between the disparity images to degrade the image quality.

### SUMMARY OF THE INVENTION

In view of the above-described circumstances, the present invention is directed to allowing high resolution printing of disparity images on a lenticular sheet.

The present invention is further directed to improving separability between disparity images of a lenticular print.

An aspect of the inkjet recording device according to the invention includes: electrostatic inkjet recording means comprising at least one nozzle for ejecting ink with an electrostatic force, the electrostatic inkjet recording means printing a plurality of disparity images by ejecting the ink onto a surface of a lenticular sheet, the lenticular sheet including an array of lenticular lenses, each lenticular lens having a predetermined width and a convex cross-sectional shape, and the disparity images being printed correspondingly to the predetermined width on the surface of the lenticular sheet opposite from a surface of the lenticular sheet having the convex shapes of the lenticular lenses; scanning means for two-dimensionally moving the electrostatic inkjet recording means relative to the lenticular sheet; and controlling means for controlling driving of the electrostatic inkjet recording means and the scanning means.

The lenticular print is formed by acquiring a plurality of disparity images of one subject taken from a plurality of points of view, cutting the disparity images into strips, and alternately printing the strips of the disparity images on each lenticular lens.

The description “the disparity images being printed correspondingly to the predetermined width” means that the strips of the disparity images taken from all the points of view corresponding to one lenticular lens are printed within the predetermined width. For example, if there are three disparity images, three strips of the disparity images, which are at corresponding positions on the images, are printed on one lenticular lens.

In the invention, the disparity images are printed with two-dimensionally moving the electrostatic inkjet recording means relatively to the lenticular sheet. As an example, the electrostatic inkjet recording means may be moved in one direction relatively to the lenticular sheet to print at least one line, and then, the electrostatic inkjet recording means may be moved in a direction perpendicular to the one direction relatively to the lenticular sheet to print the next line, and theses operations may be repeated. In the following description, the direction in which the electrostatic inkjet recording means is moved relatively to the lenticular sheet to print at least one line is referred to as a main scanning direction, and the direction perpendicular to the main scanning direction is referred to as a sub-scanning direction.

Alternatively, the relative movement of the electrostatic inkjet recording means relative to the lenticular sheet may be achieved by moving the electrostatic inkjet recording means in the main scanning direction and moving the lenticular sheet in the sub-scanning direction, or fixing the position of the lenticular sheet and moving the electrostatic inkjet recording means both in the main scanning direction and the sub-scanning direction. Further alternatively, the position of the electrostatic inkjet recording means may be fixed, and the lenticular sheet may be moved both in the main scanning direction and the sub-scanning direction.

In the inkjet recording device according to the invention, the controlling means may calculate a dot pitch and a dot diameter for the ink based on the predetermined width, a number of the disparity images to be formed within the predetermined width, and a number of dots forming an area coverage modulation matrix of the electrostatic inkjet recording means, and may control driving of the electrostatic inkjet recording means and the scanning means to print the disparity images with the dot pitch and the dot diameter.

In this case, if the electrostatic inkjet recording means is two-dimensionally moved relatively to the lenticular sheet to make the electrostatic inkjet recording means scan the lenticular sheet in the main scanning direction which is a direction perpendicular to the longitudinal direction of the lenticular lenses, the controlling means may control driving of the electrostatic inkjet recording means and the scanning means to make a dot pitch of the ink in the longitudinal direction of the lenticular lenses be equal to the calculated dot pitch.

Further, in this case, if the electrostatic inkjet recording means includes a plurality of nozzles disposed at a predetermined pitch, the controlling means may control a position of the electrostatic inkjet recording means to make an effective nozzle pitch of the nozzles coincide with the calculated dot pitch.

If the plurality of nozzles are used in the electrostatic inkjet recording means, the dots are printed at certain a pitch between the nozzles in the sub-scanning direction, and the pitch between the nozzles does not necessarily coincide with the calculated dot pitch. The description “the controlling means controls a position of the electrostatic inkjet recording means to make an effective nozzle pitch of the nozzles coincide with the calculated dot pitch” means that the electrostatic inkjet recording means may, for example, be rotated to make the pitch between the nozzles ejecting the ink of the electrostatic inkjet recording means to coincide with the calculated dot pitch, thereby making the pitch between the nozzles in the sub-scanning direction coincide with the calculated dot pitch. In the inkjet recording device according to the invention, if the electrostatic inkjet recording means is two-dimensionally moved relatively to the lenticular sheet to make the electrostatic inkjet recording means scan the lenticular sheet in a main scanning direction which is the longitudinal direction of the lenticular lenses, the controlling means may control driving of the electrostatic inkjet recording means and the scanning means so that the disparity images corresponding to at least one lenticular lens are printed with the same nozzle.

In this case, the controlling means may control driving of the electrostatic inkjet recording means and the scanning means so that the disparity images corresponding to adjacent two or more lenticular lenses are printed with the same nozzle.

In the inkjet recording device according to the invention, the controlling means may detect positional misalignment between the predetermined width and the disparity images corresponding to the predetermined width, and may control driving of the electrostatic inkjet recording means and the scanning means to correct for the positional misalignment.

In the inkjet recording device according to the invention, the controlling means may control driving of the electrostatic inkjet recording means and the scanning means to print white color over the disparity images after the disparity images have been printed.

A method for controlling the inkjet recording device according to the invention is to control the inkjet recording device according to the invention. The method includes printing the disparity images on the lenticular sheet with driving the electrostatic inkjet recording means and the scanning means to two-dimensionally move the electrostatic inkjet recording means relatively to the lenticular sheet.

According to the invention, the disparity images are printed using an electrostatic inkjet recording means. Comparing with thermal systems, etc., the electrostatic inkjet system can reduce the amount of ejected ink to 1 pl or less.

Since a very small dot pitch of the ink landing on the lenticular sheet can be provided according to the invention, the disparity images can be printed at a higher resolution. As a result, the number of points of view of the lenticular print can easily be increased, thereby allowing a wider angular range for stereoscopic viewing of the lenticular print.

Further, the electrostatic concentration inkjet system, in particular, ejects the concentrated charged particulate component of the ink with an electrostatic force, and thus a solvent content in the ejected ink is very low. Therefore, comparing with thermal systems, etc., the electrostatic concentration inkjet system can provide highly accurate landing of the ink and minimize spread of the still wet ink dots printed on the lenticular sheet, and thus, mixing of colors between the disparity images can be prevented, without providing an additional ink receiving layer.

Furthermore, since the disparity images can be printed at a higher resolution, use of the lenticular lenses with a smaller width can be allowed. This allows reduction of the height of the lenticular lenses, thereby providing improved texture and feeling of lenticular prints.

Moreover, by calculating the dot pitch and the dot diameter of the ink dots based on the predetermined width, the number of disparity images to be formed within the predetermined width, and the number of dots forming the area coverage modulation matrix of the electrostatic inkjet recording means, and controlling ejection of the ink so that the ink droplets are ejected with the calculated dot pitch and dot diameter, the disparity images can appropriately be printed according to the specification of the lenticular sheet used. Thus, there is no need of preparing the lenticular sheet tailored to the specification of the inkjet recording device, and various lenticular prints can be generated using the inkjet recording device according to the invention.

Further, in the case where the electrostatic inkjet recording means is two-dimensionally moved relatively to the lenticular sheet to make the electrostatic inkjet recording means scan the lenticular sheet in the main scanning direction which is a direction perpendicular to the longitudinal direction of the lenticular lenses, the disparity images can be printed at the calculated dot pitch by exerting control to make the dot pitch of the ink dots in the longitudinal direction of the lenticular lens be equal to the calculated dot pitch.

In the case where the electrostatic inkjet recording means includes a plurality of nozzles, printing of the disparity images at the calculated dot pitch can be ensured by controlling the position of the electrostatic inkjet recording means to make the effective nozzle pitch coincide with the calculated dot pitch.

In the case where the electrostatic inkjet recording means is two-dimensionally moved relatively to the lenticular sheet to make the electrostatic inkjet recording means scan the lenticular sheet in the main scanning direction which is the longitudinal direction of the lenticular lenses, the disparity images corresponding to at least one lenticular lens are printed with the same nozzle, so that the disparity images corresponding to one lenticular lens are printed with the nozzle having the same properties. Thus, such situation that the disparity images overlap with each other or unintentionally unprinted areas are generated between the disparity images is prevented. This can improve image separability between the disparity images, and allow successful stereoscopic viewing by the viewer who views the lenticular print generated according to the invention.

In this case, by printing the disparity images corresponding to adjacent lenticular lenses with the same nozzle, such situation that the disparity images corresponding to the adjacent lenticular lenses overlap with each other or unintentionally unprinted areas are generated between the disparity images corresponding to the adjacent lenticular lenses is prevented. Thus, image quality of the lenticular print can be improved.

Moreover, by detecting positional misalignment between the predetermined width and the disparity images corresponding to the predetermined width and correcting for the positional misalignment, successful stereoscopic viewing by the viewer who views the lenticular print generated according to the invention is allowed.

In addition, by printing white color over the disparity images, visibility of the disparity images can be improved.

### BRIEF DESCRIPTION OF THE DRAWINGS

FIG. 1 is a schematic perspective view illustrating the configuration of an inkjet recording device according to a first embodiment of the present invention,

FIG. 2 is a diagram illustrating the structure of a lenticular sheet,

FIG. 3 is a diagram for explaining how disparity images are printed,

FIG. 4 is a schematic sectional view illustrating the schematic structure of a recording head,

FIG. 5 is a schematic perspective view illustrating the schematic structure of an individual electrode of the electrostatic inkjet head according to one embodiment,

FIG. 6 is a diagram illustrating how the recording head is rotated,

FIG. 7 is a schematic perspective view illustrating the configuration of an inkjet recording device according to a second embodiment of the invention,

FIG. 8 is a diagram for explaining main scanning by the recording head in the second embodiment, and

FIG. 9 is a diagram illustrating an array of nozzles of a recording head.

### DESCRIPTION OF THE PREFERRED EMBODIMENTS

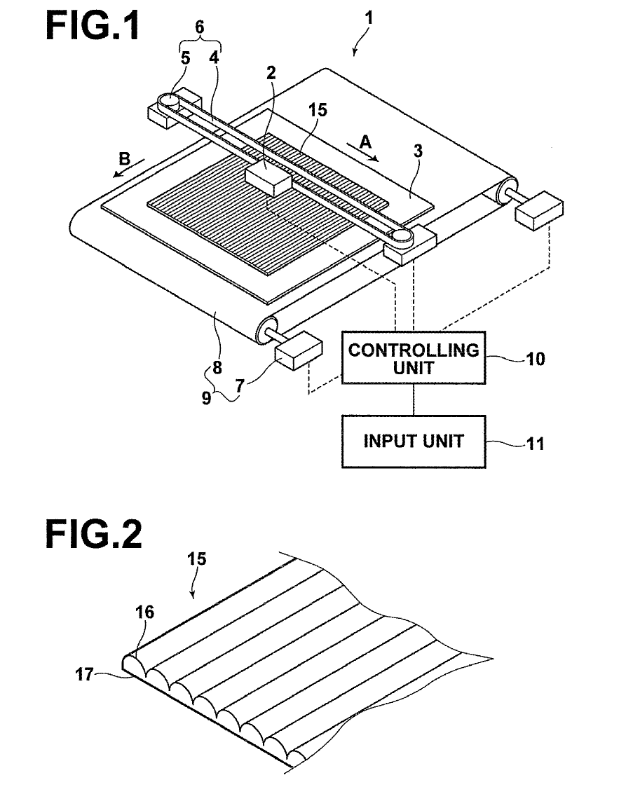

Hereinafter, embodiments of the present invention will be described with reference to the drawings. FIG. 1 is a schematic perspective view illustrating the configuration of an inkjet recording device according to a first embodiment of the invention. As shown in FIG. 1, the inkjet recording device 1 according to the first embodiment includes a recording head 2, which is an electrostatic inkjet head, and a supporting plate 3.

The recording head 2 is connected to a main scanning mechanism 6, which includes a motor 5 and a belt 4 driven by the motor 5, so that the recording head 2 is moved by the main scanning mechanism 6 to reciprocate in the main scanning direction (the direction of arrow A in the drawing). A lenticular sheet 15 used for forming a lenticular print is supported on a supporting plate 3. The supporting plate 3 supporting the lenticular sheet 15 is conveyed in the sub-scanning direction (in the direction of arrow B in the drawing) by a sub-scanning mechanism 9, which includes a motor 7 and a conveying belt 8 driven by the motor 7.

Then, the recording head 2 is driven by the main scanning mechanism 6 to scan the lenticular sheet 15 in the direction of arrow A, and an ink is ejected from the recording head 2 with conveying the lenticular sheet 15 supported on the supporting plate 3 by the sub-scanning mechanism 9 in the direction of arrow B, to print on the lenticular sheet 15.

FIG. 2 is a diagram illustrating the structure of the lenticular sheet. As shown in FIG. 2, the lenticular sheet 15 is formed by an array of substantially semi-cylindrical lenticular lenses 16, each having a predetermined width. The lenticular sheet 15 has a front surface, on which convex portions of the lenticular lenses 16 are arrayed, and a flat back surface 17 without such convex portions. The lenticular sheet 15 is placed on the supporting plate 3 with the back surface 17 facing the recording head 2.

It should be noted that the recording head 2, the main scanning mechanism 6 and the sub-scanning mechanism 9 are driven by a controlling unit 10. An input unit 11, which includes input buttons for various inputs, etc., is connected to the controlling unit 10.

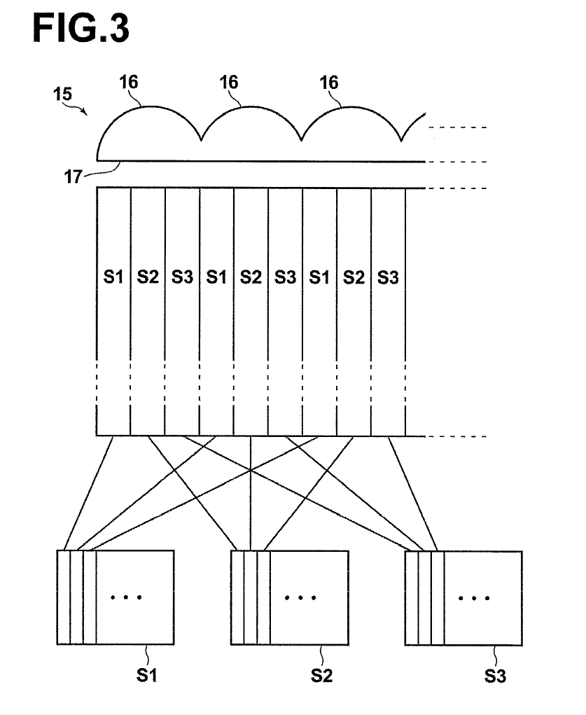

Disparity images for stereoscopic viewing are printed on the back surface 17 of the lenticular sheet 15. FIG. 3 is a diagram for explaining how the disparity images are printed. As shown in FIG. 3, in this embodiment, three disparity images S1-S3, for example, are cut into vertical strips, and the strips at corresponding positions of the three disparity images S1-S3 are alternately printed on the individual lenticular lenses 16. It should be noted that a larger number of disparity images forming a lenticular print provides a wider angular range for stereoscopic viewing of the lenticular print.

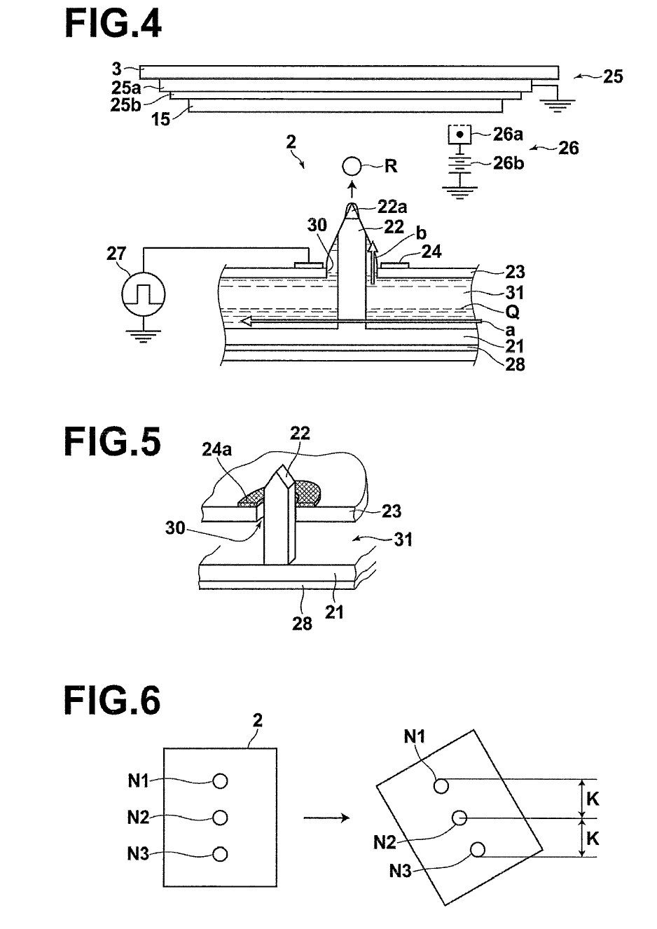

In this embodiment, the recording head is formed by an electrostatic concentration inkjet head. FIG. 4 is a schematic sectional view illustrating the schematic structure of the recording head. It should be noted that the recording head 2 and the supporting plate 3 are shown upside-down in FIG. 4 with respect to those shown in FIG. 1 for convenience of explanation. As shown in FIG. 4, the recording head 2 ejects an ink Q containing a charged particulate component, such as a pigment (toner, for example), with an electrostatic force to print the image on the lenticular sheet 15. The recording head 2 includes a head substrate 21, an ink guide 22, an insulating substrate 23, an ejection electrode 24, an opposite electrode 25 attached on the supporting plate 3, a charging unit 26 for charging the lenticular sheet 15, a signal voltage source 27 and a floating conductive plate 28.

The example shown in FIG. 4 is a conceptual expression of an individual electrode serving as a nozzle forming the recording head 2. The number of the individual electrodes (hereinafter referred to as nozzles) may be one or more without the upper limitation, and there is no limitation in physical arrangement of the nozzles. For example, a plurality of nozzles may be arranged one-dimensionally or two-dimensionally to form a line head. The recording head 2 can be used for either of monochrome or color printing.

In the recording head 2 shown in FIG. 4, the ink guide 22 is formed of a flat plate of an insulating resin having a predetermined thickness, and includes a pointed distal portion 22a. The ink guide 22 is provided on the head substrate 21 for each nozzle. The insulating substrate 23 includes a through hole 30 provided at a position corresponding to the position of the ink guide 22. The ink guide 22 passes through the through hole 30 provided in the insulating substrate 23 and the distal portion 22a projects upward from the upper surface, as in the drawing, of the insulating substrate 23. It should be noted that the ink guide 22 may include, at the center thereof, a notch in the vertical direction as in the drawing, which serves as an ink guiding groove for collecting the ink Q to the distal portion 22a with capillary action.

The distal portion 22a of the ink guide 22 is tapered toward the supporting plate 3 so that it forms a substantially triangular (or trapezoidal) shape. It should be noted that the distal portion (leading edge portion) 22a of the ink guide 22, from which the ink Q is ejected, may be coated with a metal through vapor deposition. Although the distal portion 22a of the ink guide 22 may not have the deposited metal, the deposited metal provides substantially infinite permittivity at the distal portion 22a of the ink guide 22, thereby promoting generation of an intense electric field. The shape of the ink guide 22 is not particularly limited as long as the ink Q, in particular, the charged particulate component of the ink Q can be concentrated at the distal portion 22a through the through hole 30 of the insulating substrate 23. For example, the shape of the distal portion 22a may be altered as appropriate, such as to a shape which is not pointed, or the distal portion 22a may have any known shape.

The head substrate 21 and the insulating substrate 23 are spaced apart from each other by a predetermined distance to form an ink channel 31 therebetween, which serves as an ink reservoir (ink chamber) for supplying the ink Q to the ink guide 22. It should be noted that the ink Q in the ink channel 31 contains the particulate component, which is charged in the same polarity as the polarity of the voltage applied to the ejection electrode 24. During recording, the ink Q is circulated in the ink channel 31 by an ink circulating mechanism (not shown) in a predetermined direction (in the illustrated example, from the right to the left) at a predetermined speed (for example, at an ink flow rate of 200 mm/s). In the following description, it is assumed that coloring particles in the ink are positively charged, as an example.

As shown in FIG. 5, for each nozzle, the ejection electrode 24 in the form of a ring, i.e., a circular electrode 22a, surrounding the through hole 30 in the insulating substrate 23 is disposed on the upper surface, as in the drawing, of the insulating substrate 23. The ejection electrode 24 is connected to the signal voltage source 27, which generates pulse signals (of predetermined pulse voltages, such as one having a low voltage level of 0 V and one having a high voltage level of 400-600 V) according to ejection data (ejection signal), such as image data representing an image to be printed.

It should be noted that the shape of the ejection electrode 24 is not limited to the ring-shaped circular electrode 24a shown in FIG. 5. The ejection electrode 24 may have any shape as long as it is a surrounding electrode which is disposed to surround and to be spaced apart from the outer periphery of the ink guide 22, or parallel electrodes which are disposed at opposite sides of the ink guide 22 to face to each other and to be spaced apart from the ink guide 22. If the ejection electrode 24 is a surrounding electrode, for example, the ejection electrode 24 may be a substantially circular electrode, or may be a circular electrode as shown in FIG. 5. If the ejection electrode 24 is parallel electrodes, the ejection electrode 24 may be substantially parallel electrodes. In the following description, the ring-shaped circular electrode 22a shown in FIG. 5 is used as a representative example of the surrounding electrode.

The opposite electrode 25 is supported by the supporting plate 3 to be positioned to face the distal portion 22a of the ink guide 22. The opposite electrode 25 is formed by an electrode substrate 25a and an insulating sheet 25b, which is disposed on the lower surface, as in the drawing, of the electrode substrate 25a, i.e., the surface of the electrode substrate 25a facing the ink guide 22. The electrode substrate 25a is grounded. The lenticular sheet 15 is supported on the surface of the insulating sheet 25b of the opposite electrode 25 through electrostatic adsorption, for example, and thus the opposite electrode 25 (the insulating sheet 25b) serves as a platen for the lenticular sheet 15.

At least during printing, the charging unit 26 maintains the charge on the surface of the insulating sheet 25b of the opposite electrode 25, and in turn on the lenticular sheet 15, at a predetermined high negative voltage (−1500V, for example) of opposite polarity from the polarity of the high voltage (pulse voltage) applied to the ejection electrode 24. As a result, the lenticular sheet 15 negatively charged by the charging unit 26 is always biased with the high negative voltage with respect to the ejection electrode 24 and is electrostatically adsorbed on the insulating sheet 25b of the opposite electrode 25.

The charging unit 26 includes a scorotron charger 26a for charging the lenticular sheet 15 with the high negative voltage, and a bias voltage source 26b for supplying the high negative voltage to the scorotron charger 26a. It should be noted that the charging means of the charging unit 26 used in this embodiment is not limited to the scorotron charger 26a, and any of various discharging means, such as a corotron charger, a solid-state charger and a discharge pin, may be used.

In the example shown in FIG. 4, the opposite electrode 25 is formed by the electrode substrate 25a and the insulating sheet 25b, and the lenticular sheet 15 is charged by the charging unit 26 with the high negative voltage so that the lenticular sheet 15 is electrostatically adsorbed on the surface of the insulating sheet 25b. Alternatively, the opposite electrode 25 may be formed only by the electrode substrate 25a, and the opposite electrode 25 (the electrode substrate 25a itself) may be connected to the bias voltage source for supplying the high negative voltage so that the opposite electrode 25 is always biased with the high negative voltage and the lenticular sheet 15 is electrostatically adsorbed on the surface of the opposite electrode 25.

The electrostatic adsorption of the lenticular sheet 15 onto the opposite electrode 25 and the charging of the lenticular sheet 15 with the high negative voltage or the application of the high negative bias voltage to the opposite electrode 25 may be achieved using separate high negative voltage sources. Further, the manner of the support of the lenticular sheet 15 by the opposite electrode 25 is not limited to the electrostatic adsorption, and any other supporting method or supporting means may be used.

The floating conductive plate 28 is disposed below the ink channel 31 and is electrically insulated (has high impedance). In FIG. 4, the floating conductive plate 28 is disposed at the inner side of the head substrate 21. It should be noted that, in this embodiment, the floating conductive plate 28 may be disposed at any position as long as it is disposed below the ink channel 31. For example, the floating conductive plate 28 may be disposed below the head substrate 21, or may be disposed upstream from the position of the individual electrode along the ink channel 31 and at the inner side of the head substrate 21.

During image printing, the floating conductive plate 28 causes an induced voltage to be induced depending on the value of the voltage applied to the individual electrode, so that the particulate component of the ink Q in the ink channel 31 migrates toward the insulating substrate 23 and concentrate there. Therefore, the floating conductive plate 28 needs to be disposed on the side of the ink channel 31 where the head substrate 21 is present. The floating conductive plate 28 may optionally be disposed upstream from the position of the individual electrode along the ink channel 31. Since the floating conductive plate 28 serves to increase the concentration of the charged particulate component at the upper layer of the ink Q in the ink channel 31, the concentration of the charged particulate component of the ink Q passing through the through hole 30 of the insulating substrate 23 can be increased to a predetermined concentration. Thus, the charged particulate component of the ink Q can be concentrated at the distal portion 22a of the ink guide 22, thereby allowing ejection of the ink Q as an ink droplet R having the stabilized predetermined concentration of the charged particulate component.

With the floating conductive plate 28 provided, the induced voltage is varied depending on the number of operating channels. Therefore, the charged particles necessary for ejection can be supplied without controlling the voltage applied to the floating conductive plate, and thus clogging can be prevented. It should be noted that a power source may be connected to the floating conductive plate to apply a predetermined voltage thereto.

The basic structure of the recording head 2 used in this embodiment is as described above. Now, operation of the recording head 2 is described.

In the recording head 2 shown in FIG. 4, during recording, i.e., during printing of the disparity images, the ink Q containing the particulate component, which is charged in the same polarity (for example, positive (+)) as the polarity of the voltage applied to the ejection electrode 24, is circulated in the ink channel 31 in the direction of arrow A, i.e., from the right to the left in FIG. 4, by the ink circulate mechanism (not shown) including a pump, or the like. At this time, the lenticular sheet 15, which is electrostatically adsorbed on the opposite electrode 25, is charged in the opposite polarity, i.e., the high negative voltage (−1500 V, for example). The floating conductive plate 26 is insulated (has high impedance).

When the pulse voltage is not applied to the ejection electrode 24 or the applied pulse voltage is at the low voltage level (OV), a voltage (potential difference) between the ejection electrode 24 and the opposite electrode 25 (lenticular sheet 15) is, for example, 1500 V corresponding to the bias voltage. In this state, intensity of the electric field in the vicinity of the distal portion 22a of the ink guide 22 is low, and the ink Q is not ejected from the distal portion 2a of the ink guide 22 as the ink droplet R. At this time, a part of the ink Q in the ink channel 31, in particular, the charged particulate component contained in the ink Q passes through the through hole 30 of the insulating substrate 23 and moves up in the direction of arrow b in FIG. 4, i.e., in the direction from the lower side to the upper side of the insulating substrate 23, to be supplied to the distal portion 22a of the ink guide 22, due to electrophoretic migration and capillary action.

On the other hand, when the pulse voltage at the high voltage level (400-600V, for example) is applied to the ejection electrode 24, a voltage (potential difference) between the ejection electrode 24 and the opposite electrode 25 (the lenticular sheet 15) is, for example, as high as 1900-2100 V, which is 1500 V corresponding to the bias voltage plus 400-600 V corresponding to the pulse voltage, and thus the intensity of the electric field in the vicinity of the distal portion 22a of the ink guide 22 is increased. At this time, the ink Q, in particular, the charged particulate component concentrated in the ink Q, which has moved up along the ink guide 22 to the distal portion 22a above the insulating substrate 23, is ejected as the ink droplet R containing the charged particulate component from the distal portion 22a of the ink guide 22 due to the electrostatic force. The ejected ink droplet R is attracted to the opposite electrode 25 (the lenticular sheet 15), which is biased to −1500 V, for example, and is deposited on the lenticular sheet 15.

As described above, by carrying out recording by ejecting the ink according to the image data representing the disparity images to be printed to form dots on the lenticular sheet 15 with moving the recording head 2 and the lenticular sheet 15 supported on the opposite electrode 25 relatively to each other, the disparity images are printed on the lenticular sheet 15.

Now, control of the recording head 2, the main scanning mechanism 6 and the sub-scanning mechanism 9 carried out in the first embodiment is described. First, based on the width of the lenticular lens 16, the number of disparity images to be printed on one lenticular lens 16, and the number of dots forming an area coverage modulation matrix inputted by the operator via the input unit 11, a dot pitch and the dot diameter of the ink droplets are calculated to set an ejection pulse width.

Specifically, assuming that the width of the lenticular lens 16 is 254 μm, the number of disparity images is six, and the number of dots forming the area coverage modulation matrix is two (i.e., a 2×2 matrix), a width per disparity image (strip) is 254/6=42.4 μm. Since the number of dots forming the area coverage modulation matrix is two, the dot pitch is 42.4/2=21.2 μm. The controlling unit 10 sets the bias voltage, the pulse voltage for the ejection electrode 24, a through distance (a distance between a nozzle forming surface of the recording head 2 and a print surface of the lenticular sheet 15) and the pulse width, so that the dot diameter, i.e., the amount of ink per droplet, for the dot pitch of 21.2 μm is obtained. For example, the controlling unit 10 sets the bias voltage of −1500 V, the pulse voltage for the ejection electrode 24 of 500 V, the through distance of 500 μm, the pulse width of 50 μm, and the amount of ink per ejected droplet of 0.5 pl.

With the electrostatic recording head 2, it is possible to set the dot pitch of 30 μm or less. Therefore, the controlling unit 10 controls driving of the main scanning mechanism 6 and the sub-scanning mechanism 9 to achieve the dot pitch of 21.2 μm. It should be noted that, in the first embodiment, the main scanning direction of the recording head 2 is the direction perpendicular to the longitudinal direction of the lenticular lenses 16 of the lenticular sheet 15. Therefore, the controlling unit 10 rotates the recording head 2 to make the distance between the nozzles of the recording head 2 in the sub-scanning direction coincide with the calculated dot pitch. For example, as shown in FIG. 6, if the recording head 2 has three nozzles N1-N3 arrayed in the sub-scanning direction, the controlling unit 10 rotates the recording head 2 in a plane in which the nozzles are formed (i.e., the surface of the insulating substrate 23) to make the distance between the nozzles N1 and N2 coincide with the calculated dot pitch K. It should be noted that the recording head 2 is designed such that the distance between the nozzles of the recording head 2 in the sub-scanning direction is larger than the minimum value of possible dot pitches to be used.

On the other hand, when a single main scanning is finished, the controlling unit 10 controls driving of the recording head 2, the main scanning mechanism 6 and the sub-scanning mechanism 9 to convey the lenticular sheet 15 in the sub-scanning direction by a distance of the calculated dot pitch multiplied by the number of used nozzles, and to carry out the next main scanning. For example, if the number of nozzles in the sub-scanning direction of the recording head 2 is three, as shown in FIG. 6, the controlling unit 10 controls driving of the main scanning mechanism 6 and the sub-scanning mechanism 9 to convey the lenticular sheet 15 in the sub-scanning direction by a distance of 21.2×3 μm each time a single main scanning has been finished.

By repeating the above-described operations, the disparity images are printed across the entire back surface 17 of the lenticular sheet 15.

It should be noted that, during printing, the disparity images may be printed on the lenticular sheet, similarly to the technique disclosed in the above-mentioned patent document 1, with detecting positional misalignment between the lenticular lens and the disparity images and aligning the disparity images to the lenticular lens based on the width of the lenticular lens 16, the position of the lenticular sheet 15 on the supporting plate 3 and the inclination of the lenticular sheet 15 with respect to the sub-scanning direction. In this manner, the disparity images can accurately be printed on each lenticular lens 16, thereby allowing successful stereoscopic viewing by a viewer of the generated lenticular print.

After the disparity images have been printed, a white backing may optionally be printed using a white pigment or a white dye. This can provide improved visibility of the disparity images and thus of the lenticular print.

As described above, in the first embodiment, the electrostatic recording head 2 is used to print the disparity images on the lenticular sheet 15. Comparing with thermal systems, etc., the electrostatic inkjet system allows very small amount of ejected ink, such as 1 pl or less, for example.

Therefore, according to the first embodiment, smaller dot pitch of ink droplets landing on the lenticular sheet 15 can be provided, thereby allowing higher resolution printing of the disparity images. As a result, the number of points of view of the lenticular print can easily be increased to provide a wider angular range for stereoscopic viewing of the lenticular print.

Further, the electrostatic concentration inkjet system, in particular, ejects the concentrated charged particulate component of the ink with an electrostatic force, and thus a solvent content in the ejected ink is very low. Therefore, comparing with thermal systems, etc., the electrostatic concentration inkjet system can provide a higher degree of accuracy of landing of the ink and a lower degree of spreading of the still wet ink printed on the lenticular sheet 15. Thus, mixing of colors between the disparity images can be prevented without providing an additional ink receiving layer.

Further, since the disparity images can be printed at a higher resolution, use of the lenticular lenses 16 having a smaller width can be allowed. This allows reduction of the height of the lenticular lenses 16, thereby providing improved texture and feeling of lenticular prints.

Moreover, by calculating the dot pitch and the dot diameter of the ink dots based on the width of the lenticular lens 16, the number of disparity images, and the number of dots forming the area coverage modulation matrix, and controlling the recording head 2 to eject ink droplets with the calculated dot pitch and dot diameter, the disparity images can appropriately be printed according to the specification of the lenticular sheet 15 used. Thus, there is no need of preparing the lenticular sheet 15 tailored to the specification of the inkjet recording device 1, and various lenticular prints can be generated using the inkjet recording device 1 according to this embodiment.

In addition, by rotating the recording head 2 to make the nozzle pitch in the sub-scanning direction of the recording head 2 coincide with the calculated dot pitch, printing of the disparity images at the calculated dot pitch can be ensured.

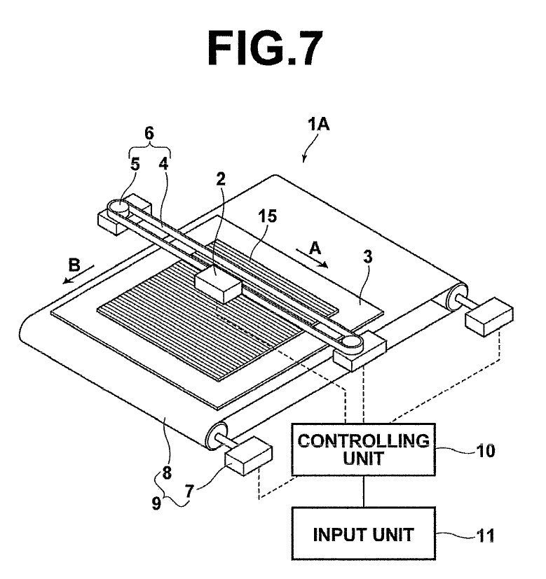

Next, a second embodiment of the invention is described. FIG. 7 is a schematic perspective view illustrating the configuration of an inkjet recording device according to the second embodiment of the invention. It should be noted that components in the second embodiment which are the same as those in the first embodiment are denoted by the same reference numerals and are not described in detail.

In the first embodiment described above, the main scanning direction of the recording head 2 is the direction perpendicular to the longitudinal direction of the lenticular lenses 16 of the lenticular sheet 15. In contrast, in the second embodiment, the lenticular sheet 15 is conveyed in such a manner that the main scanning direction of the recording head 2 coincides with the longitudinal direction of the lenticular lenses 16.

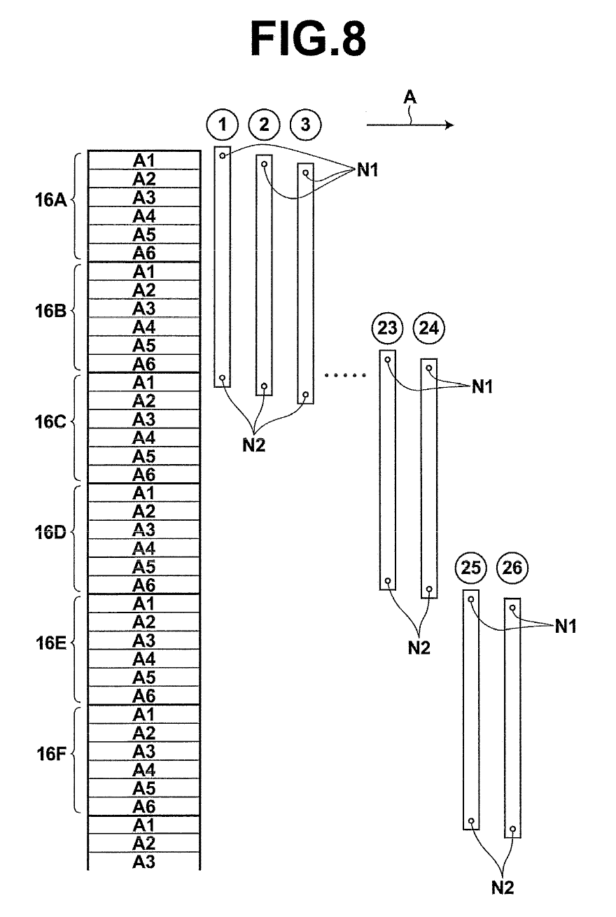

FIG. 8 is a diagram for explaining main scanning by the recording head 2 in the second embodiment. It should be noted that the scale in the longitudinal direction of the lenticular lenses 16 shown in FIG. 8 is reduced for convenience of explanation. Six lenticular lenses 16A-16F are shown in FIG. 8, and six disparity images (strips) A1-A6 are printed on each of the lenticular lenses in this example. Only two nozzles N1 and N2 in the recording head 2 for ejecting the ink are shown in FIG. 8.

It is assumed here that the lens pitch is 254 μm, the number of disparity images is six, the number of dots forming the area coverage modulation matrix is two, the width per disparity image (strip) is 254/6=42.4 μm, and the dot pitch is 42.4/2=21.2 μm. This means that one disparity image (strip) is printed with two dots (per line) in the sub-scanning direction.

In the second embodiment, the same nozzle is used to print the six disparity images (strips) on one lenticular lens 16, and further, the same nozzle is used to print disparity image groups, each including the six disparity images (strips), on adjacent two lenticular lenses 16. Specifically, as shown in FIG. 8, the groups of the six disparity images A1-A6 to be printed on the lenticular lenses 16A and 16B are printed using one nozzle, and the groups of the six disparity images A1-A6 to be printed on the lenticular lenses 16C and 16D are printed using the other nozzle. Namely, the same nozzle N1 is used to print the disparity images on the lenticular lenses 16A and 16B, and the same nozzle N2 is used to print the disparity images on the lenticular lenses 16C and 16D.

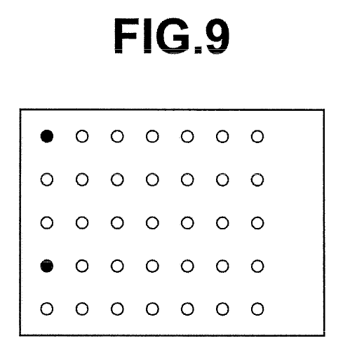

It should be noted that, in the recording head 2, the nozzles ejecting the ink are controlled such that the distance between the nozzles ejecting the ink is 508 μm, which is equivalent to the width of two lenticular lenses 16. For example, in a case where the nozzles are two-dimensionally arrayed, as shown in FIG. 9, the nozzles ejecting the ink are set such that the distance between the nozzles in the sub-scanning direction is equivalent to the width of the two lenticular lenses 16. In this case, if necessary, the recording head 2 is rotated to make the distance between the nozzles ejecting the ink in the sub-scanning direction be equal to the width of the two lenticular lenses 16, similarly to the first embodiment described above. For example, assuming that the two nozzles shown as black circles in FIG. 9 are used, and the distance between the nozzles is 800 μm, the recording head 2 is rotated to achieve the distance of 508 μm between the two nozzles.

Now, control of the recording head 2, the main scanning mechanism 6 and the sub-scanning mechanism 9 carried out in the second embodiment is described. As shown in FIG. 8, during the first main scanning, the controlling unit 10 controls the recording head 2, the main scanning mechanism 6 and the sub-scanning mechanism 9 so that the nozzle N1 prints the upper half of the disparity image A1 on the lenticular lens 16A and the nozzle N2 prints the upper half of the disparity image A1 on the lenticular lens 16C. When the first main scanning has been finished, the controlling unit 10 conveys the lenticular sheet 15 in the sub-scanning direction by the calculated dot pitch, and carries out the second main scanning.

During the second main scanning, the controlling unit 10 controls the recording head 2, the main scanning mechanism 6 and the sub-scanning mechanism 9 so that the nozzle N1 prints the lower half of the disparity image A1 on the lenticular lens 16A, and the nozzle N2 prints the lower half of the disparity image A1 on the lenticular lens 16C. When the second main scanning has been finished, the controlling unit 10 conveys the lenticular sheet 15 in the sub-scanning direction by the calculated dot pitch, and carries out the third main scanning.

During the third main scanning, the controlling unit 10 controls the recording head 2, the main scanning mechanism 6 and the sub-scanning mechanism 9 so that the nozzle N1 prints the upper half of the disparity image A2 on the lenticular lens 16A, and the nozzle N2 prints the upper half of the disparity image A2 on the lenticular lens 16C. When the third main scanning has been finished, the controlling unit 10 conveys the lenticular sheet 15 in the sub-scanning direction by the calculated dot pitch, and carries out the fourth main scanning.

The above-described main scanning and sub-scanning are repeated, and during the 24th main scanning, the controlling unit 10 controls the recording head 2, the main scanning mechanism 6 and the sub-scanning mechanism 9 so that the nozzle N1 prints the lower half of the disparity image A6 on the lenticular lens 16B, and the nozzle N2 prints the lower half of the disparity image A6 on the lenticular lens 16D. When the 24th main scanning has been finished, the controlling unit 10 conveys the lenticular sheet 15 in the sub-scanning direction by a distance corresponding to the width of the two lenticular lenses 16, and carries out the 25th main scanning.

By repeating the above-described operations, the disparity images are printed across the entire back surface 17 of the lenticular sheet 15.

As described above, in the second embodiment, the recording head 2 is moved in the main scanning direction which coincides with the longitudinal direction of the lenticular lens 16, and the disparity images (strips) A1-A6 corresponding to one lenticular lens are printed with the same nozzle. Thus, the disparity images A1-A6 corresponding to one lenticular lens are printed with the same nozzle having the same properties.

In general, directional accuracy of ejection with thermal inkjet or piezoelectric inkjet systems varies each time depending on initial variation due to the nozzle shape, etc., as well as degradation of an ink repellent treatment on the nozzle plates, depositions of ink mist around the nozzles, etc. Therefore, even when the disparity images corresponding to one lenticular lens are printed with one nozzle, landing positions of the ejected ink droplets vary. In contrast, with the electrostatic inkjet system, although errors are produced in the ejection direction due to difference of the electrostatic field between the nozzles due to shape error of the peripheral part of the nozzles, each nozzle has fixed directionality, and therefore the landing positions do not vary each time. In other words, although the ejection position error varies between the nozzles, each one nozzle has fixed ejection directionality due to the initial shape error of each nozzle section, and therefore the landing position does not randomly vary.

Thus, by printing the disparity images corresponding to one lenticular lens using one nozzle having the fixed properties of the electrostatic inkjet system, such situation that the disparity images A1-A6 overlap with each other or unintentionally unprinted areas are generated between the disparity images A1-A6 is prevented. This can improve image separability between the disparity images, and allow successful stereoscopic viewing by the viewer who views the lenticular print generated according to this embodiment.

Further, by printing the disparity images (strips) corresponding to the adjacent two lenticular lenses 16 with the same nozzle, such situation that the disparity images corresponding to the adjacent lenticular lenses 16 overlap with each other or unintentionally unprinted areas are generated between the disparity images corresponding to the adjacent lenticular lenses 16 is prevented. Thus, image quality of the lenticular print can be improved.

It should be noted that, in the second embodiment described above, although the disparity images corresponding to the adjacent two lenticular lenses 16 are printed with the same nozzle, the disparity images corresponding to adjacent three or more lenticular lenses 16 may be printed with the same nozzle.

Further, in the second embodiment, the disparity images may be printed on the lenticular sheet with aligning the disparity images to each lenticular lens, similarly to the above-described first embodiment. Furthermore, after the disparity images have been printed, a white backing may be printed using a white pigment or a white dye.

In the above-described first and second embodiments, although the belt-conveying sub-scanning mechanism 9, which conveys the lenticular sheet 15 placed on the supporting plate 3 with the conveying belt 8, is used, a drum-conveying sub-scanning mechanism may be used instead. In this case, the lenticular sheet 15 is wrapped around a drum and the drum is rotated to effect the sub-scanning. It should be noted that, since the lenticular sheet 15 is typically stiffer than a paper sheet, use of the belt-conveying sub-scanning mechanism 9 may be preferred to provide higher through distance accuracy.

In the above-described first and second embodiments, although the disparity images are printed on the lenticular sheet 15 with conveying the lenticular sheet 15 by the sub-scanning mechanism 9 and driving the recording head 2 by the main scanning mechanism 6, the position of the lenticular sheet 15 may be fixed and only the recording head 2 may be moved both in the main scanning direction and the sub-scanning direction to print the disparity images. Alternatively, the position of the recording head 2 may be fixed and only the lenticular sheet 15 may be moved both in the main scanning direction and the sub-scanning direction to print the disparity images.

What is claimed is:

1. An inkjet recording device comprising:
electrostatic inkjet recording means comprising at least one nozzle for ejecting ink with an electrostatic force, the electrostatic inkjet recording means printing a plurality of disparity images by ejecting the ink onto a surface of a lenticular sheet, the lenticular sheet including an array of lenticular lenses, each lenticular lens having a predetermined width and a convex cross-sectional shape, and the disparity images being printed correspondingly to the predetermined width on the surface of the lenticular sheet opposite from a surface of the lenticular sheet having the convex shapes of the lenticular lenses;
scanning means for two-dimensionally moving the electrostatic inkjet recording means relative to the lenticular sheet; and
controlling means for controlling driving of the electrostatic inkjet recording means and the scanning means.

2. The inkjet recording device as claimed in claim 1, wherein the controlling means calculates a dot pitch and a dot diameter for the ink based on the predetermined width, a number of the disparity images to be formed within the predetermined width, and a number of dots forming an area coverage modulation matrix of the electrostatic inkjet recording means, and controls driving of the electrostatic inkjet recording means and the scanning means to print the disparity images with the dot pitch and the dot diameter.

3. The inkjet recording device as claimed in claim 2, wherein the electrostatic inkjet recording means is two-dimensionally moved relatively to the lenticular sheet to make the electrostatic inkjet recording means scan the lenticular sheet in a main scanning direction which is a direction perpendicular to the longitudinal direction of the lenticular lenses, and the controlling means controls driving of the electrostatic inkjet recording means and the scanning means to make a dot pitch of the ink in the longitudinal direction of the lenticular lenses be equal to the calculated dot pitch.

4. The inkjet recording device as claimed in claim 3, wherein the at least one nozzle of the electrostatic inkjet recording means comprises a plurality of nozzles disposed at a predetermined pitch, and the controlling means controls a position of the electrostatic inkjet recording means to make an effective nozzle pitch of the nozzles coincide with the calculated dot pitch.

5. The inkjet recording device as claimed in claim 1, wherein the electrostatic inkjet recording means is two-dimensionally moved relatively to the lenticular sheet to make the electrostatic inkjet recording means scan the lenticular sheet in a main scanning direction which is the longitudinal direction of the lenticular lenses, and the controlling means controls driving of the electrostatic inkjet recording means and the scanning means so that the disparity images corresponding to at least one lenticular lens are printed with the same nozzle.

6. The inkjet recording device as claimed in claim 5, wherein the controlling means controls driving of the electrostatic inkjet recording means and the scanning means so that the disparity images corresponding to adjacent two or more lenticular lenses are printed with the same nozzle.

7. The inkjet recording device as claimed in claim 1, wherein the controlling means detects positional misalignment between the predetermined width and the disparity images corresponding to the predetermined width, and controls driving of the electrostatic inkjet recording means and the scanning means to correct for the positional misalignment.

8. The inkjet recording device as claimed in claim 1, wherein the controlling means controls driving of the electrostatic inkjet recording means and the scanning means to print white color over the disparity images after the disparity images have been printed.

9. A method for controlling the inkjet recording device of claim 1, the method comprising printing the disparity images on the lenticular sheet with driving the electrostatic inkjet recording means and the scanning means to two-dimensionally move the electrostatic inkjet recording means relatively to the lenticular sheet.
